(19) United States
(12) Patent Application Publication
(10) Pub. No.: US 2005/0105144 A1
(43) Pub. Date: May 19, 2005

(54) Image reading apparatus

(75) Inventor: Tatsuya Konagaya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/988,498

(22) Filed: Nov. 16, 2004

(30) Foreign Application Priority Data
Nov. 18, 2003 (JP) 2003-388288

(51) Int. Cl. H04N 1/04

(52) U.S. Cl. 358/497; 358/486

(57) ABSTRACT

An imaging section of an image reading apparatus is mainly constituted of an image forming lens unit, a lens barrel, a holder plate and a CCD area scan sensor. The image forming lens unit is held in the lens barrel that is mounted to a bottom side of the holder plate. The CCD area scan sensor is mounted on a top side of the holder plate. Piezoelectric elements are mounted on the holder plate, for moving the imaging section in two directions that are orthogonal to each other, and 45 degrees to film lengthwise and widthwise directions respectively. For the pixel shift, the image forming lens unit is moved together with the CCD area scan sensor, so the required accuracy of movement is not so strict.

### FIELD OF THE INVENTION

The present invention relates to an image reading apparatus that reads an image from an original through an area scan sensor, wherein image data is picked up a number of times from different image pickup positions on the original while moving the area scan sensor by a very small amount.

### BACKGROUND ARTS

Image reading apparatuses include photo film scanners, and read images photo-electrically from originals, like photographic film. The image reading apparatus is provided with a photoelectric conversion device for converting an optical image to an electric signal, and an image forming lens for forming the optical image on the photoelectric conversion device, wherein the optical image is formed from light that is reflected from or transmitted through an original. As the photoelectric conversion device, CCD (charge-coupled device) area scan sensors are widely used, wherein a large number of photoelectric conversion elements, hereinafter called photoelectric pixels, are arranged two-dimensionally on a photoreceptive surface.

In order to raise the resolution of the obtained image, it is desirable to raise the number of photoelectric pixels of the CCD area scan sensor. With an increase in the pixel number, however, the interval between the individual pixels, i.e. the pixel size will decrease if not the size of the photoreceptive surface of the CCD area scan sensor is unchanged. The decrease in pixel-interval or pixel-size will worsen the sensitivity or the dynamic range of the CCD area scan sensor.

To solve this problem, Japanese Laid-open Patent Application No. 2002-94724, especially in page 3, discloses an image reading apparatus that reads an original image a number of times while moving a CCD area scan sensor by a very small amount in a plane parallel to its photoreceptive surface. This method is called Pixel Shift, and is effective to raise the resolution of the obtained image without making the pixel size smaller.

Since the CCD area scan sensors have recently been improved in properties as well as in signal processing ability, it is preferable to minimize the CCD area scan sensor, thereby to minimize the image reading apparatus and save the cost of the image reading apparatus. For example, if a CCD area scan sensor having 3,200,000 pixels arranged in a honeycomb structure is reduced in size from 1.1 inches to 1/1.7 inches, the spacing between the closest pixels will decrease from 10.7 μm to 3.8 μm, that is, about one third of the former spacing. For use in the pixel shift method, and if an individual image is assumed to be read four times, the 1/1.7 inch CCD area scan sensor must be moved by 1.9 μm at a time, whereas the 1.1 inch CCD area scan sensor must be moved by 5.35 μm at a time. On the assumption that the tolerance range of movement of the CCD area scan sensor, within which the quality of the read image is not remarkably affected, is defined to be 20% of the required amount, the tolerated error will be 1.07 μm with respect to the 1.1 inch CCD area scan sensor, whereas it is limited to 0.38 μm with respect to the 1/1.7 inch CCD area scan sensor. Accordingly, the accuracy of movement of the 1/1.7 inch CCD area scan sensor is restricted to one third of that of the 1.1 inch CCD area sensor, so the smaller CCD area scan sensor needs a highly accurate shift mechanism for the pixel shift. The highly accurate shift mechanism will raise the manufacture cost, and also needs a larger mounting space, which will enlarge the whole scale of the image reading apparatus.

### SUMMARY OF THE INVENTION

In view of the foregoing, a primary object of the present invention is to provide an image reading apparatus that can enhance the image resolution by the pixel shift, even with a smaller size CCD area scan sensor without the need for stricter accuracy of movement.

An image reading apparatus of the present invention comprises an area scan sensor having photoelectric conversion pixels arranged in a two-dimensional arrangement on a photoreceptive surface, to convert an optical image formed on the photoreceptive surface into electric signals; an image forming lens for forming an optical image on the photoreceptive surface of the area scan sensor from light beams that are transmitted through or reflected from an illuminated original image; and a shift device for shifting image pickup positions of the area scan sensor step by step relative to the original image by moving the area scan sensor and the image forming lens together in parallel to the photoreceptive surface.

It is preferable to change the amount of movement of the area scan sensor and the image forming lens in inverse proportion to optical magnification of the image forming lens.

According to a preferred embodiment, the original image includes a picture frame photographed on a photo filmstrip, and the photoelectric conversion pixels are arranged in a honeycomb structure with respect to lengthwise and widthwise directions of the photo filmstrip.

According to another preferred embodiment, the shift device causes the area scan sensor to move in first and second moving directions that are orthogonal to each other, and are 45 degrees to the lengthwise and widthwise directions of the photo filmstrip.

According to the image reading apparatus of the present invention, the image forming lens is moved together with the area scan sensor in parallel to the photoreceptive surface of the area scan sensor, as the area scan sensor is moved for the pixel shift. Then, the required accuracy of movement of the area scan sensor becomes less strict in comparison with a case where the area scan sensor alone is moved. Therefore, it is possible to carry out the pixel shift with a smaller size area scan sensor without the need for a highly accurate shift mechanism. So the image reading apparatus can be manufactured at a low cost.

### BRIEF DESCRIPTION OF THE DRAWINGS

The above and other objects and advantages will become more apparent from the following description of the preferred embodiments when read in conjunction with the accompanying drawings, wherein like reference numerals designate like or equivalent elements throughout the several views, wherein:

FIG. 1 is a schematic diagram illustrating a digital photo-lab system using an image reading apparatus according to an embodiment of the present invention;

FIG. 2 is a top plan view of an imaging section of the image reading apparatus of FIG. 1;

FIG. 3 is a side view of the imaging section;

FIG. 4 is an explanatory diagram illustrating image pickup positions of individual photoelectric pixels in a case where the pixel shift is carried out once for one original image;

FIG. 5 is an explanatory diagram illustrating image pickup positions of individual photoelectric pixels in a case where the pixel shift is carried out three times for one original image; and

FIG. 6 is an explanatory diagram illustrating image pickup positions of individual photoelectric pixels in a case where the pixel shift is carried out seven times for one original image.

### DETAILED DESCRIPTION OF THE PREFERRED EMBODIMENTS

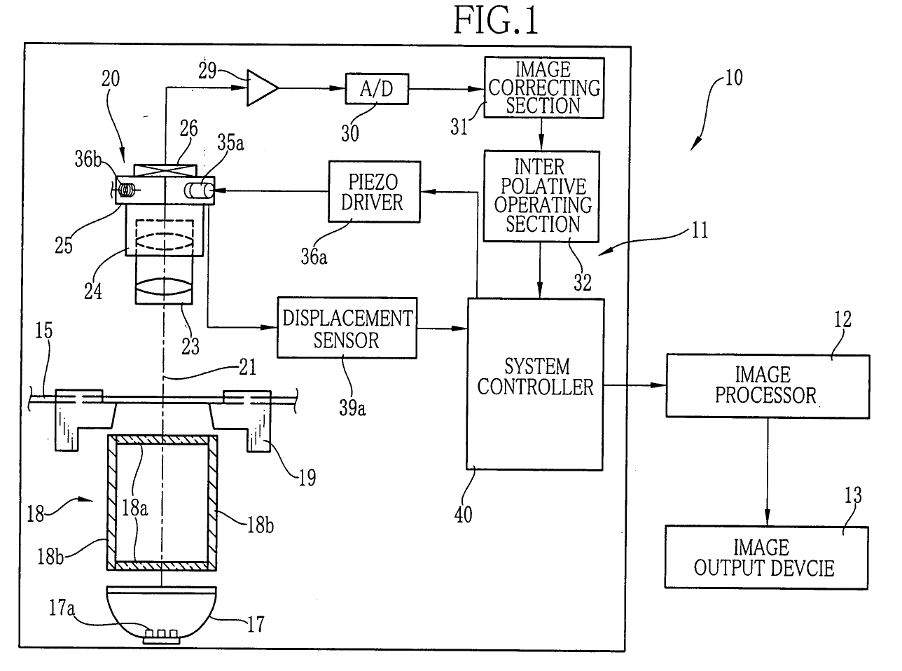

FIG. 1 is a schematic diagram illustrating a digital photo-lab system embodying the present invention. The digital photo-lab system 10 consists of an image reading apparatus 11, an image processor 12 and an image output device 13. The image reading apparatus 11 reads an image of an individual photographic picture frame from a photo filmstrip 15, and outputs image data of the read image to the image processor 12.

The image processor 12 processes the image data for correcting color, density, gradation, gray balance and other designated properties of the image. The image output device 13 records a latent image on a photosensitive material, e.g. photographic paper, by exposing the photosensitive material in accordance with the image data from the image processor 12. Thereafter, the image output device 13 processes the exposed photosensitive material for development, to output it as a photo print.

The image reading apparatus 11 is mainly constituted of a light source 17, a diffusion box 18, a film carrier 19, and an imaging section 20, which are arranged in this order along an optical axis 21 of the light source 17. The light source 17 has a large number of light emitting diodes (LED) 17a arranged in a matrix, which emit red, green, blue and infrared light beams. The light source 17 is connected to a not-shown LED driver, which controls timing of activation and light volume of the respective LEDs 17a, so that the LEDs 17a are turned on and off sequentially from one color to another. Thereby, each original image is read according to the three-color separation method. The infrared light beams are used for detecting extraneous objects on the photo filmstrip 15, abrasion of the photo filmstrip 15, or the like. It is to be noted that the light source may be constituted of a halogen lamp and color filters, instead of the LEDs 17a.

The diffusion box 18 is constituted of a pair of light diffusion plates 18a, which are placed on the optical axis 21, and reflection plates 18b surrounding an air gap between the light diffusion plates 18a. The light beams from the light source 17 are diffused in the diffusion box 18, and then projected as illumination light toward the film carrier 19.

The film carrier 19 is prepared for each individual kind of photo filmstrips that are supposed to be read by the image reading apparatus 11. From among the plural kinds of film carriers, one corresponding to the kind of the present photo filmstrip 15 is selected and set in the image reading apparatus 11. For example, the film carrier for ISO 135 type photo filmstrip has a film passageway for the 135 type photo filmstrip and a corresponding exposure opening, though they are not illustrated in detail in the drawings. For the image reading, a not-show film feeding mechanism feeds the photo filmstrip 15 through the film passageway, to position the photographic picture frame one after another in the exposure opening of the film carrier 19.

The imaging section 20 is mainly constituted of an image forming lens unit 23, a lens barrel 24, a holder plate 25 and a CCD area scan sensor 26. The image forming lens unit 23 forms an optical image on a photoreceptive surface of the CCD area scan sensor 26 from light beams that pass through the photographic picture frame of the photo filmstrip 15, as illuminated with the illumination light. The image forming lens unit 23 is held in the lens barrel 24 so as to be movable along the optical axis. 21. The lens barrel 24 is mounted on a bottom side of the holder plate 25. The holder plate 25 is formed with a not-shown opening for letting light pass through it. The CCD area scan sensor 26 is mounted on the top of this opening, so the light from the picture frame, i.e. the optical image formed through the image forming lens unit 23, falls on the photoreceptive surface of the CCD area scan sensor 26 via the opening of the holder plate 25.

The CCD area scan sensor 26 outputs analog picture signals. The picture signals are amplified by an amplifier 29 and, thereafter, converted into digital image data through an A/D converter 30. The image data is sent to an image correcting section 31, where the image data is processed for many kinds of image corrections, such as DC offset correction, dark hour correction, and shading correction. The image data corrected in the image correcting section 31 are processed for interpolation in an interpolative operating section 32, as set forth in detail later, if pixels of the image data are to be rearranged. Thereafter, the image data are sent to the image processor 12. If the data pixels are not to be rearranged, the image data are sent to the image processor 12 without being processed for interpolation.

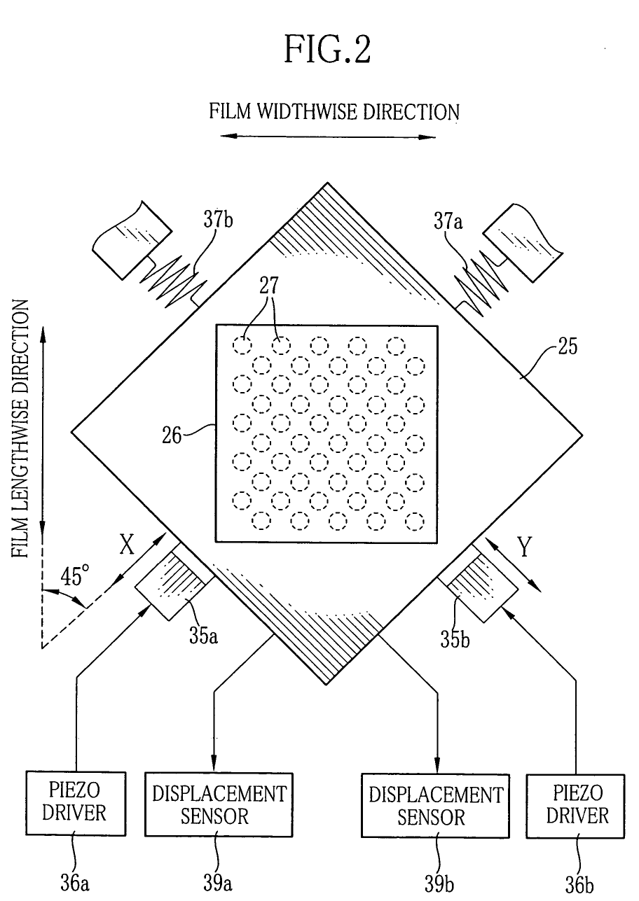

As shown in FIG. 2, photoelectric conversion elements or photoelectric pixels 27 are arranged on the photoreceptive surface of the CCD area scan sensor 26 in alignment with lengthwise and widthwise directions of the photo filmstrip 15, wherein the pixels of each row are staggered from those of the next row (the honeycomb structure). In FIG. 2, the photoelectric pixels 27 are illustrated larger and apart from each other, for the sake of clarifying the pixel arrangement. But the actual diameter of the photoelectric pixels 27 is several μm, and a huge number of pixels are arranged tightly on the photoreceptive surface.

Piezoelectric elements 35a and 35b are mounted on neighboring two of four sides of the square holder plate 25. The piezoelectric elements 35a and 35b are for causing the CCD area scan sensor 26 to move by a very small amount for the pixel shift. In the same way as disclosed in the above mentioned prior art, the piezoelectric elements 35a and 35b are positioned such that the CCD area scan sensor 26 as mounted on the holder plate 25 is moved in two directions that are indicated by X and Y in the drawings, and the X- and Y-directions form an angle of 45 degrees to the lengthwise and widthwise directions of the photo filmstrip 15.

The amount of displacement of the individual piezoelectric element 35a or 35b, that is, the amount of movement of the CCD area scan sensor 26, is controlled by piezo driver 36a or 36b respectively. The holder plate 25 is also provided with biasing members 37a and 37b that bias the holder plate 25 and thus the CCD area scan sensor 26 toward their initial positions against the movement caused by the piezoelectric element 35a or 35b in the X direction or the Y direction.

The amount of movement of the holder plate 25 in the X direction or the Y direction is measured by a displacement sensor 39a or 39b respectively. The displacement sensors 39a and 39b are for example laser or optical displacement sensors or inductance displacement sensor. Measurement data of the displacement sensors 39a and 39b, which respectively represent measured amounts of movement in the X direction and the Y direction, are send to a system controller 40, as shown in FIG. 1. The system controller 40 controls the overall operation of the image reading apparatus, and is constituted of a CPU and memories, though they are omitted from the drawing.

The system controller 40 is connected to the interpolative operating section 32, the piezo drivers 36a and 36b, the displacement sensors 39a and 39b, and other not-shown elements, including a control panel and an image data output section for outputting the image data to the image processor 12. To avoid complicating the drawing, the piezoelectric element 35b and the associated piezo driver 36b and displacement sensor 39b are omitted from the block diagram of FIG. 1, though they are connected in the same way as for the piezoelectric element 35a and the associated piezo driver 36a and displacement sensor 39a. The system controller 40 controls the amount of displacement of the piezoelectric elements 35a and 35b on the basis of the measurement data that are fed back from the displacement sensors 39a and 39b respectively.

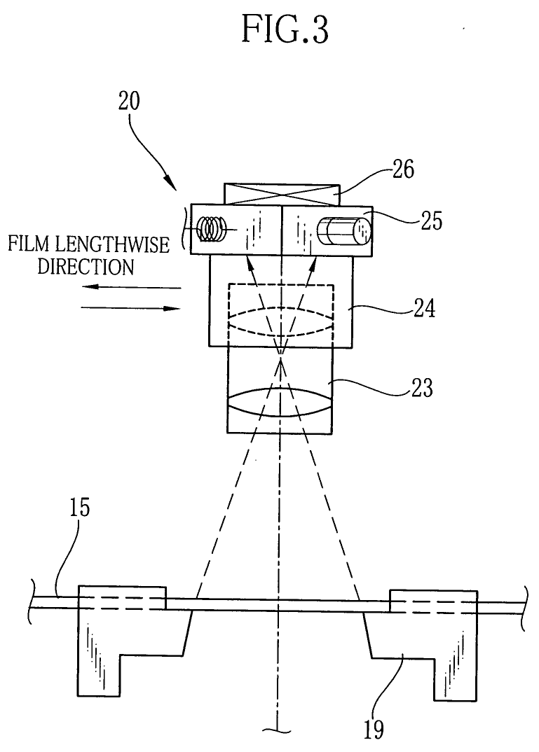

As shown in FIG. 3, the image forming lens unit 23 and the CCD area scan sensor 26 are united through the lens barrel 24 and the holder plate 25 into an integral body. Accordingly, as the holder plate 25 is moved by the piezoelectric elements 35a and 35b, the image forming lens unit 23 and the CCD area scan sensor 26 are moved together with the holder plate 25. This is equivalent to moving the film carrier 19 and thus the photographic picture frame of the photo filmstrip 15 while keeping the image forming lens unit 23 and the CCD area scan sensor 26 stationary.

Assuming that the optical image of the photographic picture frame is formed on the photoreceptive surface of the CCD area scan sensor 26 at a predetermined optical magnification “n” through the image forming lens unit 23, the optical image formed on the CCD area scan sensor 26 will be displaced by an amount n·L/n=L, as the photographic picture frame moves by an amount L/n in a perpendicular direction to the optical axis 21. Accordingly, moving the holder plate 25 by the amount L/n (=L·1/n), that is, moving the image forming lens unit 23 together with the CCD area scan sensor 26 by the amount L/n is equivalent to moving the CCD area scan sensor 26 alone by the amount L.

For example, where the optical magnification of the image forming lens unit 23 is n=0.2, and individual image pickup positions of the CCD area scan sensor 26 are to be shifted by 1.9 μm at each step of pixel-shifting, the holder plate 25 has to move by 1.90·1/0.2=1.90/0.2=9.50 μm at each step. Assuming that the accuracy of movement is required to be plus minus 20% of the set value, it is plus minus 0.4 (=1.90·0.2) μm where the CCD area scan sensor 26 alone is moved for the pixel shift, whereas it is plus minus 2.0 (=0.4/0.2) μm where the CCD area scan sensor 26 is moved together with the image forming lens unit 23. Consequently, the tolerance range in accuracy of movement is widened 5 times that of the case where the CCD area scan sensor 26 alone is moved. So the image reading apparatus 11 does not need any high accuracy shift mechanism for the CCD area scan sensor 26, thereby saving the cost of the apparatus.

It is to be noted that the optical magnification of the image forming lens unit 23 must be changed depending upon the size of the photographic picture frame, that is, according to the type of the photo filmstrip 15. With the change in optical magnification, the amount of movement of the holder plate 25 necessary for the pixel shift, i.e. L/n, will change. In other words, the necessary amount of movement is in inverse proportion to the optical magnification “n”.

Therefore, the system controller 40 has a data table memory that correlates available values of the optical magnification “n” of the image forming lens unit 23 to necessary amounts of movement of the holder plate 25, or a lookup table memory that memorizes arithmetic operation formulas or the like for determining the necessary amount of movement by the optical magnification “n”. Since the amount of displacement of the individual piezoelectric element 35a or 35b is controlled in accordance with the optical magnification of the image forming lens unit 23, the respective image pickup positions are maintained unchanged.

In the image reading apparatus 11 of the present embodiment, how many times the pixel shift is carried out is determined according to the required resolution. That is, when a small size photo print is to be output from the image output device 13, the number of times of pixel-shifting is reduced. On the contrary, when a large size photo print is to be made, the pixel-shifting is carried out many times. Therefore, the system controller 40 preferably has a lookup table memory that stores a data table assigning available print sizes to the required numbers of times of the pixel shift, or the like, so that the number of times of the pixel shift is automatically set up when the photo print size is designated, for example, by the operator through the control panel or the like.

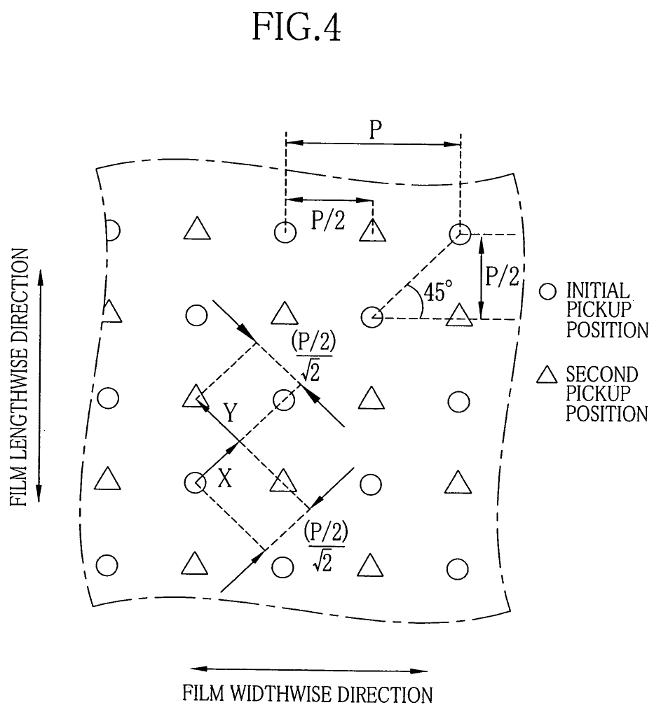

Now the sequences of image picking up processes will be described with respect to three cases as illustrated in FIGS. 4 to 6, wherein the pixel shift is carried out for different number of times from each other. In FIGS. 4 to 6, P designates the interval of the photoelectric pixels 27 in the film widthwise direction. That is, the photoelectric pixels 27 are arranged at constant intervals of P along the film widthwise direction. The photoelectric pixels 27 of one row that extends in the film widthwise direction are staggered by the half interval P/2 from those of the next row. On the other hand, the interval between the rows in the film lengthwise direction is P/2.

FIG. 4 illustrates a first pixel shift pattern for a case where the pixel shift is carried out once for each original image.

Since the optical image is formed sequentially color by color from one original in the present embodiment, two frames of image data are picked up for each color. That is, the image data are picked up twice for each color, before and after the pixel shift. This pixel shift pattern is adopted for making an enlarged photo print that is a little larger than a standard size, e.g. twice the standard size, from a picture frame of the ordinary ISO 135 type photo filmstrip, or for making a photo print of a trimmed or cropped image at a slightly larger print magnification.

First, the CCD area scan sensor 26 picks up image data color by color at initial pickup positions indicated by white circles in the drawings, to output a first data frame of each color.

Next, the pixel shift is carried out by moving the CCD area scan sensor 26 and the image forming lens unit 23 together with the holder plate 25. As shown in FIG. 4, the holder plate 25 and thus the CCD area scan sensor 26 are moved by an amount (P/2)/v2 in the X direction and then by the amount (P/2)/v2 in the Y direction, to shit the respective pixels 27 from the initial pickup positions to respective second pickup positions as indicated by white triangles in FIG. 4.

A second data frame of each color is obtained at these second pickup positions. As shown in FIG. 4, data pixels obtained at the initial and second pickup positions are in a square grid arrangement. Accordingly, it is unnecessary to rearrange the data pixels of an image obtained by combining the first and second data frames of each color. So the image data is sent to the image processor 12 without being rearranged through the interpolative operating section 32.

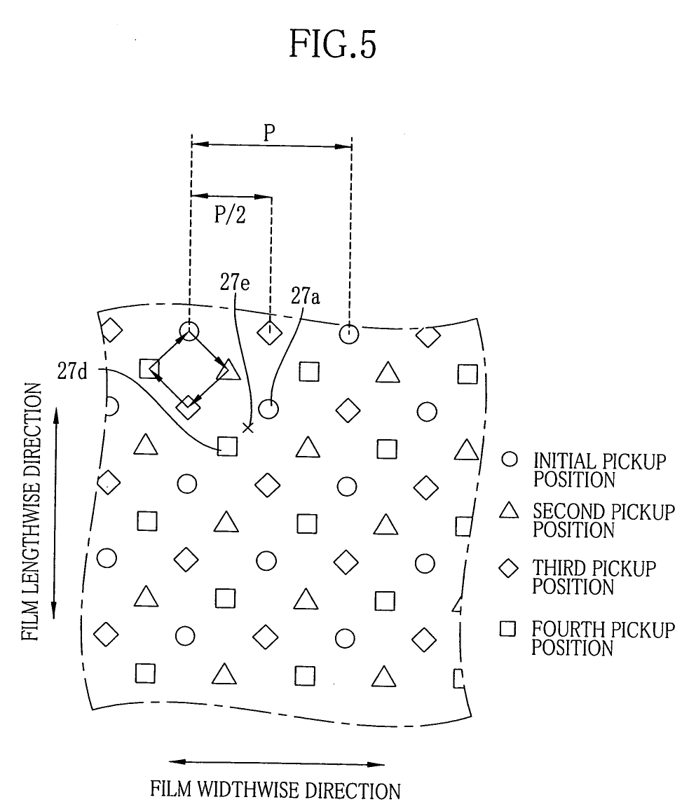

Next, a second pixel shift pattern for a case where the pixel shift is carried out three times for each original image will be described with reference to FIG. 5, wherein obtained data pixels are rearranged through the interpolative operating section 32. In this case, four data frames are obtained for each color from one original. This is adopted for making a photo print of a larger size, e.g. 8×10 inch size, in comparison with the above described first case.

As shown FIG. 5, the CCD area scan sensor 26 reads the optical image one color after another at the initial pickup positions indicated by white circles. Next, the piezo driver 36b drives the piezoelectric element 35b to move the holder plate 25 in the Y direction by the amount (P/2)/v2 to shift the photoelectric pixels 27 of the CCD area scan sensor 26 to respective second pickup positions that are indicated by white triangles in FIG. 5. At the second pickup positions, a second data frame of each color is picked up.

Next, the piezo driver 36a drives the piezoelectric element 35a to move the holder plate 25 in the X direction by the amount (P/2)/v3 to shift the photoelectric pixels 27 to respective third pickup positions that are indicated by white lozenges in FIG. 5. At the third pickup positions, a third data frame of each color is picked up. Next, the piezo driver 36b drives the piezoelectric element 35b to move the holder plate 25 in the Y direction by the amount (P/2)/v2 to shift the photoelectric pixels 27 of the CCD area scan sensor 26 to respective fourth pickup positions that are indicated by white squares in FIG. 5. At the fourth pickup positions, a fourth data frame of each color is picked up. Thereafter, the piezoelectric element 35a is driven to move the photoelectric pixels 27 to the initial pickup positions (∘), for scanning the next original picture frame.

In this case, the interpolative operating section 32 rearranges data pixels by use of interpolative operation, in a manner as disclosed in the above mentioned prior art. Concretely, image data of closest two pixels are processed to obtain an interpolation pixel that is interpolated into an intermediate position between these two pixels. The interpolation pixel is obtained from every pair of nearest two pixels, and the obtained interpolation pixels alone are output as image data, so that the pixels of the output image data are arranged in a square grid structure.

In the above description, the closest two pixels are those image data which are picked up at two adjacent pickup positions which are closest to each other among all pickup positions, including the initial pick up positions and the second to fourth pickup position in the case shown in FIG. 5. For example, as shown in FIG. 5, an interpolation pixel is produced from image data picked up at the initial pickup position 27a of one photoelectric pixel 27, i.e. a data pixel at the position 27a, and a data pixel at the fourth pickup position 27d. And the interpolation pixel is interpolated into an intermediate position 27e indicated by “+” between the initial and fourth pickup positions 27a and 27d. In the same way, interpolation pixels are produced from all data pixels picked up from one original, and interpolated into respective intermediate positions. Then the intermediate positions are held as output pixel positions, so that merely the interpolation pixels are sent as output image data to the system controller 40.

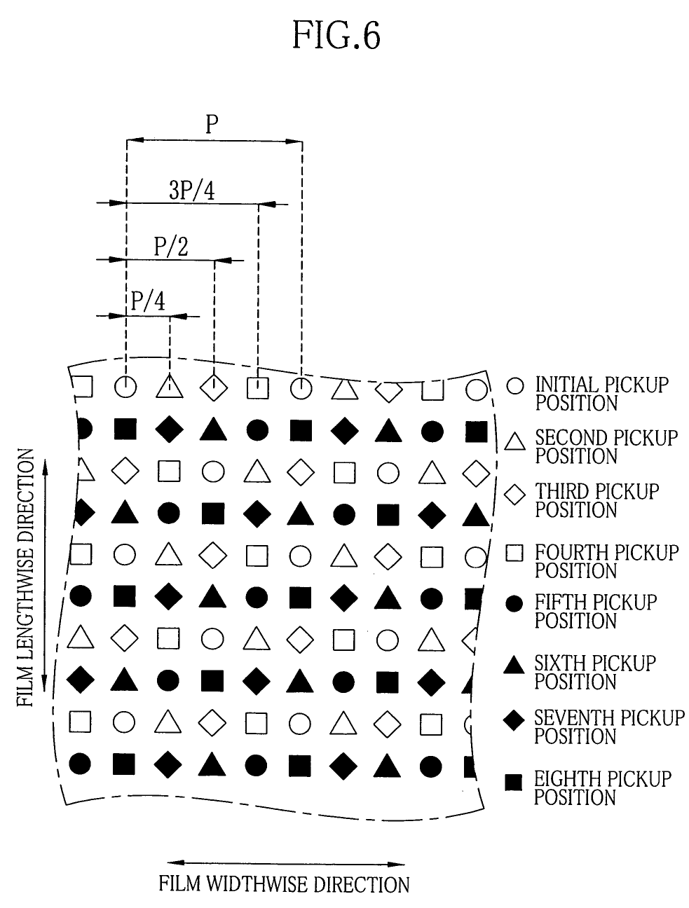

FIG. 6 illustrates a third pixel shift pattern for a case where the pixel shift is carried out seven times for one original image. In this case, eight data frames are obtained for each color from one original. This case is adopted for making a maximum size photo print in the digital photo-lab system 10. First, the CCD area scan sensor 26 picks up image data color by color at initial pickup positions indicated by white circles in the drawings, to output a first data frame of each color. Next, the piezoelectric elements 35a and 35b are driven to shift the photoelectric pixels 27 to respective second pickup positions, which are indicated by white triangles in FIG. 6, and are shifted from the initial pickup positions by P/4 in one film widthwise direction, i.e. to the right hand side in FIG. 6. At the second pickup positions, a second data frame of each color is picked up.

Thereafter, the piezoelectric elements 35a and 35b are driven to shift the photoelectric elements 27 by P/4 to the right hand side, so a third data frame of each color is picked up at third pickup positions indicated by white lozenges in FIG. 6. In the same way, the photoelectric elements 27 are shifted by P/4 to the right hand side, so a fourth data frame of each color is picked up at fourth pickup positions indicated by white squares.

In the fourth step of pixel shift, the photoelectric elements 27 are shifted from the fourth pickup positions by P/4 in one film lengthwise direction, i.e. downward FIG. 6. Thus, a fifth data frame of each color is picked up at fifth pickup positions indicated by black circles in FIG. 6. In the fifth step of pixel shift, the photoelectric elements 26 are shifted from the fifth pickup positions by P/4 in the other film widthwise direction, i.e. to the left hand side in FIG. 6, as indicated by black circles in FIG. 6. At the sixth pickup positions, a sixth data frame of each color is picked up. Thereafter, the piezoelectric elements 35a and 35b are driven to shift the photoelectric elements 27 by P/4 to the left hand side, so a seventh data frame of each color is picked up at seventh pickup positions indicated by black lozenges in FIG. 6. In the same way, the photoelectric elements 27 are shifted by P/4 to the right hand side, so a eighth data frame of each color is picked up at eighth pickup positions indicated by black squares.

In this way, eight frames of image data are picked up for each color from one original image.

As shown in FIG. 6, the data pixels obtained by combining the eight data frames of one color are equivalent to those data pixels which are picked up by photoelectric pixels arranged in a square grid structure along the film widthwise and lengthwise directions. Therefore, it is unnecessary to rearrange the data pixels. So the image data are sent to the image processor 12, while the respective pickup positions of the eight data frames are being designated as output pixel positions.

Now the operation of the present embodiment will be described.

Before entering a print command, the operator designates through the control panel or the like the size of photo prints to make, to sets up how many times the pixel shift is to be carried out for one original image, wherein the CCD area scan sensor 26 is shifted together with the image forming lens unit 23.

In response to the print command entered by the operator, the type of the photo filmstrip 15 is detected, to set up the optical magnification of the image forming lens unit 23 in accordance with the film type. On the other hand, a picture frame of the photo filmstrip 15 is positioned appropriately in the exposure opening of the film carrier 19. Next, the LEDs 17a of the light source 17 illuminate the picture frame with red, green, blue and infrared light beams in a color sequential fashion. Light beams going past through the picture frame are formed through the image forming lens unit 23 into an optical image on the photoreceptive surface of the CCD area scan sensor 26 that is in the initial pickup position.

After the CCD area scan sensor 26 picks up a data frame for each color at the initial pickup position, the system controller 40 drives either one or both of the piezoelectric elements 35a and 35b to shift the CCD area scan sensor 26 to the second pickup position, depending upon the set number of times of the pixel shift, that is, according to the set pixel shift pattern. To drive the piezoelectric elements 35a and 35, the system controller 40 controls the piezo drivers 36a and 36b while monitoring the measurement data from the displacement sensors 39a and 39b, which indicate the amount of movement of the CCD area scan sensor 26. Thereby, the movement error of the CCD area scan sensor 26 is kept within a tolerance range, or a required accuracy. Since the image forming lens unit 23 is moved together with the CCD area scan sensor 26, the required accuracy of movement is less strict in comparison with the case where the CCD area scan sensor 26 alone is moved. After the CCD area scan sensor 26 is moved to the second pickup position, the optical image of each color is read in the same way as in the initial pickup position. Thereafter, if more than one pixel shift is necessary, the optical image is read color by color in the following pickup positions in the same way in the initial pickup position after each of the set number of pixel shift steps. When the same picture frame is scanned a predetermined number of times in this way, the next picture frame is positioned in the exposure opening of the film carrier 19. Then image data of the next picture frame is picked up in the same way.

The analog picture signals output from the CCD area scan sensor 26 are amplified by the amplifier 29 and, thereafter, converted into digital image data through the A/D converter 30. The image data is processed in the image correcting section 31, where the image data for many kinds of image corrections, such as DC offset correction, dark hour correction, and shading correction. The corrected image data is sent to the image processor 12, if necessary, after being subjected to the pixel rearrangement in the interpolative operating section 32.

The image data is processed in the image processor 12 for correcting color, density, gradation, gray balance and other designated properties of the image, and then sent to the image output device 13. The image output device 13 records a latent image on a photosensitive material by exposing the photosensitive material in accordance with the image data from the image processor 12. Thereafter, the image output device 13 processes the exposed photosensitive material for development, to output it as a photo print.

Although the above embodiment uses the piezoelectric elements 35a and 35b as a device for moving the image forming lens unit 23 and the CCD area scan sensor 26 together, the present invention is not to be limited to the piezoelectric elements, but magnetostrictive elements are usable instead. The magnetostrictive element changes its length with a change of magnetic field. In that case, electromagnetic coils or the like are disposed for exciting or actuating the magnetostrictive elements. By controlling current applied to the actuation coils, the amount of movement of the image forming lens unit 23 and the CCD area scan sensor 26 is controlled. If the speed of printing is not so important, a pulse motor or the like may be used for controlling the movement, instead of the piezoelectric elements or the magnetostrictive elements.

In the above embodiment, the piezoelectric elements 35a and 35b are controlled in the feedback method while monitoring data of moved amount of the CCD area scan sensor 26 and the holder plate 25, which is measured by the displacement sensors 39a and 39b. But the present invention is not to be limited to this method. In an alternative, a capacitor of a known capacitance is connected in series to each of the piezoelectric elements 35a and 35b. By measuring the voltage across these capacitors, electric charge values accumulated in the individual piezoelectric elements 35a and 35b are detected, so that it is possible to control the voltage applied to either of the piezoelectric elements 35a and 35b, so as to keep the voltage across the corresponding capacitor in a constant value. In this way, the voltage applied to the piezoelectric element 35a or 35b is controlled exactly, so it is possible to control the amount of movement of the CCD area scan sensor 26 exactly.

The above embodiment describes three pixel shift patterns for the three cases where the pixel shift is carried out once or three times or seven times for one original image. But the number of pixel shift steps is not to be limited to these three options, but the present invention is applicable to a case where the pixel shift is carried out another number of times, such as more than seven times.

Although the piezoelectric elements 35a and 35b are mounted to the holder plate 25 in the above embodiment, they may be mounted to the lens barrel 24 or other portions insofar as they can move the CCD area scan sensor 26 together with the image forming lens unit 23.

Although the optical image is formed on the photoreceptive surface of the CCD area scan sensor 26 from the light beams that are transmitted through the original, i.e. the photo filmstrip 15 in the above embodiment, the present invention is not limited to this configuration, but applicable to an image reading apparatus that reads an image from a reflective original.

In that case, light beams reflected from an illuminated reflective original are focused as an optical image on the photoreceptive surface of the CCD area scan sensor 26.

In conclusion, the present invention is not to be limited to the illustrated embodiments but, on the contrary, various modifications will be possible without departing from the scope of claims appended hereto.

1. An image reading apparatus comprising:
an area scan sensor having photoelectric conversion pixels arranged in a two-dimensional arrangement on a photoreceptive surface, to convert an optical image formed on said photoreceptive surface into electric signals;
an image forming lens for forming an optical image on said photoreceptive surface of said area scan sensor from light beams that are transmitted through or reflected from an illuminated original image; and
a shift device for shifting image pickup positions of said area scan sensor step by step relative to said original image by moving said area scan sensor and said image forming lens together in parallel to said photoreceptive surface.

2. An image reading apparatus as claimed in claim 1, wherein said area scan sensor and said image forming lens are moved by an amount that varies in inverse proportion to optical magnification of said image forming lens.

3. An image reading apparatus as claimed in claim 1, wherein said original image includes a picture frame photographed on a photo filmstrip, and said photoelectric conversion pixels are arranged in a honeycomb structure with respect to lengthwise and widthwise directions of the photo filmstrip.

4. An image reading apparatus as claimed in claim 3, wherein said shift device causes said area scan sensor to move in first and second moving directions that are orthogonal to each other, and are 45 degrees to said lengthwise and widthwise directions of said photo filmstrip.

5. An image reading apparatus as claimed in one of claims 1 to 4, wherein said shift device comprise piezoelectric elements.

6. An image reading apparatus as claimed in one of claims 1 to 4, wherein said shift device comprise magnetostrictive elements.

7. An image reading apparatus as claimed in one of claims 1 to 4, wherein said shift device comprises a feedback control device for controlling moving said area scan sensor while monitoring an actual amount of movement.

8. An image reading apparatus as claimed in claim 3, wherein said image pickup positions comprise an initial pickup position and a second pickup position with respect to each of said photoelectric conversion pixels, said second pickup position being shifted from said initial pickup position in said lengthwise or said widthwise direction by an amount P/2, wherein P represents an interval between said photoelectric conversion pixels in said lengthwise and widthwise directions, and wherein images are picked up at said initial pickup positions and said second pickup positions from each original image.

9. An image reading apparatus as claimed in claim 3, wherein said image pickup positions comprise an initial pickup position and second to fourth pickup positions with respect to each of said photoelectric conversion pixels, said second pickup position being shifted from said initial pickup position in said first or said second moving direction by an amount (P/2)/v2, wherein P represents an interval between said photoelectric conversion pixels in said lengthwise and said widthwise directions, said third pickup position being shifted from said second pickup position in said second or said first moving direction by the amount (P/2)/v2 so as to be shifted from said initial pickup position by an amount P/2 in said lengthwise or said widthwise direction, said fourth pickup position being shifted from said third pickup position toward said initial pickup position in said first or said second moving direction by the amount (P/2)/v2, and wherein images are picked up sequentially from said initial pickup positions with respect to each original image.

10. An image reading apparatus as claimed in claim 3, wherein said image pickup positions comprise an initial pickup position and second to eighth pickup positions with respect to each of said photoelectric conversion pixels, said second pickup position being shifted from said initial pickup position in said widthwise direction by an amount P/4, wherein P represents an interval between said photoelectric conversion pixels, said third pickup position being shifted from said second pickup position in the widthwise direction by the amount P/4 to opposite side from said initial position, said fourth pickup position being shifted from said third pickup position further in the same direction by the amount P/4, said fifth pickup position being shifted from said fourth position in said lengthwise direction by the amount P/4, said sixth to eighth pickup positions being shifted respectively from said third, second and initial pickup positions in said lengthwise direction by the amount P/4, and wherein images are picked up sequentially from said initial pickup positions with respect to each original image.
